(19) United States
(12) Patent Application Publication
(10) Pub. No.: US 2022/0211203 A1
(43) Pub. Date: Jul. 7, 2022

(54) SUPER ANTI-SLIP COMPOSITE CARPET WITH THREE-DIMENSIONAL TPE ELASTIC STRUCTURE AND COMPOUNDING PROCESS THEREOF

(71) Applicant: HAINING SHUTAN CARPET TECHNOLOGY CO., LTD., Zhejiang (CN)

(72) Inventor: Caifeng HONG, Zhejiang (CN)

(73) Assignee: HAINING SHUTAN CARPET TECHNOLOGY CO., LTD., Zhejiang (CN)

(21) Appl. No.: 17/607,458

(22) PCT Filed: Jul. 26, 2019
(86) PCT No.: PCT/CN2019/097847

§ 371 Date: Oct. 29, 2021

(30) Foreign Application Priority Data
Apr. 30, 2019 (CN) 201910361219.7

(51) Int. Cl. A47G 27/02; B29C 48/00; B29C 48/08; B29C 48/155; B32B 27/12; B32B 27/32; B32B 27/30

(52) U.S. Cl. CPC A47G 27/0281; B29C 48/002; B29C 48/08; B29L 2031/7322; B32B 27/12; B32B 27/32; B32B 27/302; B29C 48/155

(57) ABSTRACT

A super anti-slip composite carpet with a three-dimensional TPE elastic structure, which is formed by compounding a fabric layer (1) and a TPE layer (2), wherein TPE is composed of 80-90% of styrene oxide-butadiene block copolymer and 10-20% of polypropylene, and the TPE layer (2) has a thickness of 1-2 mm. The compounding process thereof includes: step 1, preheating a transparent TPE to 80° C., and adding to a material barrel of a casting machine, stirring the TPE by a screw, and heating to a heating temperature of 140° C.-200° C. in 6-9 sections, to obtain a paste-like TPE; step 2, extruding the paste-like TPE through a metal joining pipe into a die head; step 3, making the paste-like TPE flow out through the die head in a planar cascade shape, and at the same time, passing the paste-like TPE flowed out from the die head together with a back part of a carpet fabric through a gap between an embossed roller and a rubber roller, so as to compound with the bottom surface of the fabric layer. The carpet has a good anti-slip effect and no edge warping, and is light resistant, aging resistant, non-toxic and tasteless, safe and reliable.

### TECHNICAL FIELD

The present disclosure relates to a residential carpet and a production method thereof, and in particular to a super anti-slip composite carpet with a three-dimensional thermoplastic elastomer (TPE) elastic structure and a compounding process thereof.

### BACKGROUND

At present, the existing conventional residential flooring decoration materials include: wooden floor, marble, plate, and ceramic tile. However, the conventional residential carpets on the market could not achieve a good anti-slip effect on these flooring decoration materials. The existing residential carpets include: 1. latex composite carpet, which has strong smell and poor wear resistance, and will result in dregs falling on the floor if carpeted, and will fall faster when exposed to water; 2. ethylene-vinyl acetate (EVA) copolymer foam carpet, which has good slip-resistance and is soft, but has a sharp odor, and will make the room with an awful smell; 3. rubber powder composite carpet, which will make the whole room full of peculiar smell of rubber if carpeted; and 4. sponge carpet, which has good slip-resistance and is soft, but is not resistant to oxidation and abrasion, and absorbs water easily.

### SUMMARY

The technical problem to be solved by the present disclosure is to provide a super anti-slip composite carpet with a three-dimensional TPE elastic structure and a compounding process thereof. The composite carpet has a good anti-slip effect and no edge warping, and is light resistant, aging resistant, non-toxic and tasteless, safe and reliable.

To solve the technical problem, the present disclosure provides the following technical solution:

A super anti-slip composite carpet with a three-dimensional TPE elastic structure, which is formed by compounding a fabric layer and a TPE layer, wherein the TPE is composed of 80-90% of styrene oxide-butadiene block copolymer and 10-20% of polypropylene, and the TPE layer has a thickness of 1-2 mm.

In some embodiments, the TPE layer is provided with a pattern layer on a bottom surface thereof, and the TPE layer and the pattern layer are an integrated structure.

In some embodiments, the fabric layer is a polyester fabric layer, a wool fabric layer, a nylon fabric layer or a silk fabric layer.

A compounding process of the super anti-slip composite carpet with a three-dimensional TPE elastic structure, comprising:

step 1, preheating a transparent TPE to 80° C., and adding to a material barrel of a casting machine, stirring the transparent TPE by a screw, and heating to a temperature of 140° C.-200° C. in 6-9 sections, to obtain a paste-like TPE;

step 2, extruding the paste-like TPE through a metal joining pipe into a die head; and

step 3, making the paste-like TPE flow out through the die head in a planar cascade shape, and at the same time, passing the paste-like TPE flowed out from the die head together with a back part of a carpet fabric through a gap between an embossed roller and a rubber roller, so as to compound with the bottom surface of the fabric layer.

In some embodiments, the die head has a length of 2.8 m, and is provided with 9-13 heating sections, wherein two heating sections at the two extreme ends of the die head are heated at a temperature of 190-200° C., and middle sections of the die head are heated at a temperature of 180-190° C.

In some embodiments, the embossed roller is a 3D square round rod with a chrome plated flower, which could firmly bond the TPE layer with the carpet fabric to provide a square 3D three-dimensional shape.

In some embodiments, the metal joining pipe is provided with a heating section.

The TPE carpet emulsion adhesive of the present disclosure adopts a new material which is prepared by saturating the double bonds in TPE molecules by means of hydrogenation. Since the saturated TPE has a saturated olefinic structure in its soft segment, it has better weather resistance, heat aging resistance, ozone resistance, toughness and thermal stability than the TPE, which fundamentally solves the problems of high and low temperature resistance and yellowing of TPE, thereby expanding the application scope of products.

The carpet according to the present disclosure may be placed on wooden floors, marbles, ceramic tiles, glass, metal plates and leather, without sliding, dregs and peculiar smell, and with extreme durability. The super anti-slip elastic carpet with a three-dimensional TPE that does not scratch the wooden floor is a good carpet, which could protect children and the elderly from falling and tripping, and is suitable for wide popularization and use.

The present disclosure has the following beneficial effects: TPE is compounded with the back part of the carpet, making the carpet with clear texture, and be transparent and clean, non-slip and environmentally friendly, soft and tough, temperature resistance of −50° C. to +70° C., wear resistant and anti-aging (5-10 years). The carpet is free from deformation, cracking, edge warping and sliding. The carpet has good anti-slip and leveling performance, thus completely avoiding the hidden dangers of children and the elderly from falling caused by stepping on the carpet and hooking to the edge of the carpet, or from falling back caused by the carpet sliding.

### BRIEF DESCRIPTION OF THE DRAWINGS

FIG. 1 shows a structure diagram according to an Example of the present disclosure.

### DETAILED DESCRIPTION OF PREFERRED EMBODIMENTS

The present disclosure will be further illustrated below in combination with the drawings.

### Example 1

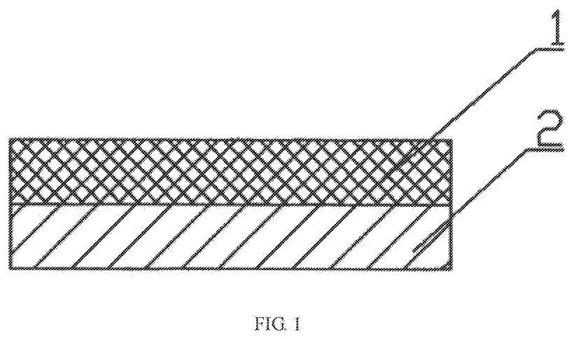

As shown in FIG. 1, a super anti-slip composite carpet with a three-dimensional TPE elastic structure was formed by compounding a fabric layer 1 and a TPE layer 2. The TPE was composed of 85% of styrene oxide-butadiene block copolymer and 15% of polypropylene, and the TPE layer 2 had a thickness of 2 mm. The TPE layer 2 was provided with a pattern layer on a bottom surface thereof, and the TPE layer 2 and the pattern layer were an integrated structure. The fabric layer 1 was a wool fabric layer.

The following is a test table of friction coefficients of 5 kinds of composite carpet samples, among them, A, B, C and D are existing market fabrics, E is a super anti-slip composite carpet with a three-dimensional TPE elastic structure of the present disclosure; specifically, A is a polyester flocking composite carpet, B is a polypropylene composite carpet, C is a polyester composite carpet, D is a polyester jacquard composite carpet, and E is a super anti-slip TPE and wool composite carpet.

| | | | Experimental | | Test |
|---|---|---|---|---|---|
| Test item | Test method | Instrument | Environment | Sample | result |
| Static friction | ISO 8295:1995 | Friction coefficient/ | 23 ± 2° C. | A | 0.548 |
| coefficient (μs) | | Peeling Test | 50 ± 5% RH | B | 0.461 |
| | | Instrument FPT-F1 | | C | 0.726 |
| | | test speed of 100 | | D | 1.16 |
| | | mm/min | | E | 1.71 |
| Dynamic friction | ISO 8295:1995 | Friction coefficient/ | 23 ± 2° C. | A | 0.543 |
| coefficient (μk) | | Peeling Test | 50 ± 5% RH | B | 0.441 |
| | | Instrument FPT-F1 | | C | 0.686 |
| | | test speed of 100 | | D | 1.10 |
| | | mm/min | | E | 1.35 |

The following is a sensory and smell test table for the above 5 kinds of composite carpet samples:

| | | | | | | Test |
|---|---|---|---|---|---|---|
| Test item | Test method | Sample | Description | Pretreatment | Staff | result |
| Sensory and | VDA270-2018 | A | Black fabric | 7 days | 1 | 3.0 level |
| smell | | | | 23° C. | 2 | 3.0 level |
| | | | | | 3 | 3.5 level |
| | | | | | 4 | 3.5 level |
| | | | | | 5 | 3.5 level |
| | | | | | Average value | 3.5 level |

| Test item | Test method | Sample | Description | Pretreatment | Staff | Test result |
|---|---|---|---|---|---|---|
| Sensory | VDA270-2018 | B | Grey/black felt | 7 days | 1 | 2.5 level |
| and smell | | | with grey solid | 23° C. | 2 | 3.0 level |
| | | | pieces | | 3 | 3.0 level |
| | | | | | 4 | 3.0 level |
| | | | | | 5 | 3.0 level |
| | | | | | Average value | 3.0 level |

| Test item | Test method | Sample | Description | Pretreatment | Staff | Test result |
|---|---|---|---|---|---|---|
| Sensory and | VDA270-2018 | C | White felt | 7 days | 1 | 2.5 level |
| smell | | | with white fabric | 23° C. | 2 | 3.5 level |
| | | | | | 3 | 3.0 level |
| | | | | | 4 | 3.0 level |
| | | | | | 5 | 3.0 level |
| | | | | | Average value | 3.0 level |

| Test item | Test method | Sample | Description | Pretreatment | Staff | Test result |
|---|---|---|---|---|---|---|
| Sensory and | VDA270-2018 | D | Colored felt | 7 days | 1 | 3.0 level |
| smell | | | with beige solid | 23° C. | 2 | 3.0 level |
| | | | | | 3 | 3.0 level |
| | | | | | 4 | 3.0 level |
| | | | | | 5 | 3.0 level |
| | | | | | Average value | 3.0 level |

| Test item | Test method | Sample | Description | Pretreatment | Staff | Test result |
|---|---|---|---|---|---|---|
| Sensory | VDA270-2018 | E | White felt with | 7 days | 1 | 3.0 level |
| and smell | | | translucent solid | 23° C. | 2 | 3.0 level |
| | | | | | 3 | 3.0 level |
| | | | | | 4 | 3.0 level |
| | | | | | 5 | 3.0 level |
| | | | | | Average value | 3.0 level |

Under the conditions that both the sensory and smell reach the requirements of the existing products, the carpet has a good anti-slip effect and no edge warping, and is light resistant, aging resistant, non-toxic and tasteless, safe and reliable.

### Example 2

A compounding process of a super anti-slip composite carpet with a three-dimensional TPE elastic structure was performed as follows:

Step 1, a transparent TPE was preheated to 80° C., and then added into a material barrel of a casting machine. The TPE was stirred by a screw, and heated to a temperature of 140° C.-200° C. in 6-9 sections, obtaining a paste-like TPE.

Step 2, the paste-like TPE was extruded through a metal joining pipe into a die head, wherein the metal joining pipe is provided with a heating section.

Step 3, the paste-like TPE flowed out through the die head in a planar cascade shape, and at the same time, the paste-like TPE flowed out from the die head was passed together with a back part of a carpet fabric through a gap between an embossed roller and a rubber roller, so as to compound with the bottom surface of the fabric layer, wherein the embossed roller is a 3D square round rod with a chrome plated flower, which could firmly bond the TPE layer with the carpet fabric to provide textures.

The die head had a length of 2.8 m, and was provided with 9-13 heating sections, and two heating sections at the two extreme ends of the die head were heated at a temperature of 190-200° C., and middle sections of the die head were heated at a temperature of 180-190° C.

### Example 3

A second super anti-slip composite carpet with a three-dimensional TPE elastic structure was formed by compounding a fabric layer 1 and a TPE layer 2. The TPE was composed of 90% of styrene oxide-butadiene block copolymer and 10% of polypropylene, and the TPE layer 2 had a thickness of 1 mm. The TPE layer 2 was provided with a pattern layer on a bottom surface thereof, and the TPE layer 2 and the pattern layer were an integrated structure. The fabric layer 1 was a silk fabric layer.

### Example 4

A third super anti-slip composite carpet with a three-dimensional TPE elastic structure was formed by compounding a fabric layer 1 and a TPE layer 2. The TPE was composed of 80% of styrene oxide-butadiene block copolymer and 20% of polypropylene, and the TPE layer 2 had a thickness of 1.5 mm. The TPE layer 2 was provided with a pattern layer on a bottom surface thereof, and the TPE layer 2 and the pattern layer were an integrated structure. The fabric layer 1 was a nylon fabric layer.

What is claims is:

1. A super anti-slip composite carpet with a three-dimensional TPE elastic structure, which is formed by compounding a fabric layer (1) and a TPE layer (2), wherein the TPE is composed of 80-90% of styrene oxide-butadiene block copolymer and 10-20% of polypropylene, and the TPE layer (2) has a thickness of 1-2 mm.

2. The super anti-slip composite carpet with a three-dimensional TPE elastic structure of claim 1, wherein the TPE layer (2) is provided with a pattern layer on a bottom surface thereof, and the TPE layer (2) and the pattern layer are an integrated structure.

3. The super anti-slip composite carpet with a three-dimensional TPE elastic structure of claim 1, wherein the fabric layer (1) is a polyester fabric layer, a wool fabric layer, a nylon fabric layer or a silk fabric layer.

4. A compounding process of a super anti-slip composite carpet with a three-dimensional TPE elastic structure, comprising:
step 1, preheating a transparent TPE to 80° C., and adding the preheated transparent TPE into a material barrel of a casting machine, stirring the TPE by a screw, and heating to a temperature of 140° C.-200° C. in 6-9 sections, to obtain a paste-like TPE;
step 2, extruding the paste-like TPE through a metal joining pipe into a die head; and
step 3, making the paste-like TPE flow out through the die head in a planar cascade shape, and at the same time, passing the paste-like TPE flowed out from the die head together with a back part of a carpet fabric through a gap between an embossed roller and a rubber roller, so as to compound with the bottom surface of the fabric layer.

5. The compounding process of claim 4, wherein the die head has a length of 2.8 m, and is provided with 9-13 heating sections, wherein two sections at the two extreme ends of the die head is heated at a temperature of 190-200° C., and middle sections of the die head are heated at a temperature of 180-190° C.

6. The compounding process of claim 4, wherein the embossed roller is a 3D square round rod with a chrome plated flower, which firmly bonds the TPE layer with the carpet fabric to provide textures.

7. The compounding process of claim 4, wherein the metal joining pipe is provided with a heating section.
